(19) United States
(12) Patent Application Publication
(10) Pub. No.: US 2014/0029248 A1
(43) Pub. Date: Jan. 30, 2014

(54) LAMP

(71) Applicants: Jacob Dyson, London (GB); Douglas Andrew Inge, London (GB); Samuel Emrys James, London (GB)

(72) Inventors: Jacob Dyson, London (GB); Douglas Andrew Inge, London (GB); Samuel Emrys James, London (GB)

(73) Assignee: Jacob Dyson, London (GB)

(21) Appl. No.: 13/561,489

(22) Filed: Jul. 30, 2012

(51) Int. Cl. F21V 21/14; F21V 5/04; F21V 29/00

(52) U.S. Cl. 362/218; 362/220; 362/244

(57) ABSTRACT

A lighting device is disclosed which includes a vertical support, an elongate horizontal arm connected to the vertical support via a connector, and a light source mounted on the arm. The elongate arm consists of, or consists essentially of, an elongate heat sink, and the lighting device further comprises an elongate heat pipe positioned within the heat sink and in thermal contact with the light source. The elongate arm and the vertical support include elongate channels formed along at least a portion of their lengths, and the connector comprises a sheet structure having a plurality of wheels rotatably mounted thereon, wherein the wheels are arranged to ride along the elongate channels, such that the elongate arm can slide relative to the vertical support in directions both parallel to and perpendicular to the length of the arm. The elongate arm and connector are connected to a counterweight via a flat, flexible power cable arranged around first and second pulley wheels. The light source comprises a plurality of light emitting diodes, each of which is mounted with its lens pointing through a respective frustoconical surface.

### FIELD OF THE INVENTION

The present invention relates to lighting devices and particularly lamps such as desk lamps and floor-standing lamps.

### BACKGROUND TO THE INVENTION

A wide range and variety of lighting devices, and particularly desk lamps and floor-standing lamps, currently exists.

For example, balanced-arm lamps are well known. Such lamps include an adjustable folding arm mounted on a base, and with a light source and shade mounted at the end of the folding arm. Such lamps are constructed so that the force due to gravity acting on the arm and lighting components is always counteracted by springs, regardless of the position of the arms of the lamp. The intention is that the light source can be held stationary and positioned to direct light in a large number of directions. However, in practice, it is often difficult to accurately position the light source in the desired position as the springs may not be exactly balanced so that the light source may be moved by the force of the springs once the user has let go of the arm. In addition, the arrangement of arms, springs and power cable generally mean that the light source can only be moved a limited amount in each direction, e.g. up and down, clockwise and anti-clockwise, before the movement is limited by interaction between the folding arm or base, and the power cable, for example.

In recent years the use of LEDs in consumer lighting devices has significantly increased as a consequence of the potential for increased service life and increased energy efficiency over conventional fluorescent and incandescent bulbs. However, the heat produced by LEDs can reduce the service life and light output of the LEDs, as well as the consistency over time of the colour of the light output from the LEDs. In addition, LEDs do not emit light in all directions, and the directional characteristics of the emitted light affects the design of lamps as well as the appearance and uniformity of the light that is emitted. In particular, LED light sources can produce light over a working area which has a non-homogeneous radiation profile including spots and rings of higher and lower intensity.

It is known to use heat pipe and heat sink technology to cool LED lighting systems. Such known cooling systems generally remove heat from the vicinity of the light source using a heat pipe which then dissipates the heat via a heat sink which comprises a series of stacked circular or radial fins surrounding the heat pipe. The fins are generally thin and fragile and take up a significant volume close to the light source, such that they significantly add to the volume and bulkiness of the lighting device.

In view of the problems outlined above, an aim of the present invention is to provide a lamp having a light source which can be positioned easily and accurately, and held stationary in any position within a particular space.

A further aim of the present invention is to provide a lighting system which efficiently dissipates heat away from the light source without significantly adding to the size and volume of the lighting system close to the light source.

A further aim of the present invention is to provide an efficient lighting system which illuminates wide areas with a homogenous, flat radiation profile, i.e. without areas of higher or lower intensity.

### SUMMARY OF THE INVENTION

The above aims are addressed by a lighting system that has been invented by the inventors named on the present application. To satisfy all of the above aims, the lamp includes all four of the following inventive concepts. However, it is intended that the following four inventive concepts may be incorporated within a lighting system either individually, or in combination with one or two of the other inventive concepts, to address one or more of the above aims.

In a first aspect of the invention, there is provided a lighting device comprising:

an elongate arm; and

a light source mounted on the arm, wherein

the elongate arm consists of, or consists essentially of, an elongate heat sink; and further comprising:

an elongate heat pipe positioned within the heat sink and in thermal contact with the light source.

In a particular embodiment, the elongate arm comprises an elongate horizontal arm.

The terms “horizontal”, “vertical”, “top” and “bottom” are used in the context of the present application to refer to relative positions of components of the lighting device when in normal use. The term “elongate arm” is used to mean an arm which has a length that is significantly larger than its maximum thickness.

The light source may be mounted close to a first end of the arm. Alternatively, the light source may be mounted close to a centre of the arm.

The lighting device may further comprise a base and a vertical support mounted on the base, wherein the elongate arm is mounted on the vertical support. The vertical support may be elongated such that its length is significantly larger than its maximum thickness.

The vertical support may be connected to the base via a jack plug which allows for unlimited rotation of the vertical support relative to the base whilst also providing for an electrical connection between the light source and an electrical connector which is mounted in or on the base and is connectable to a power source.

The lighting device may further comprise at least one switch for turning the light source on and off. The at least one switch may also be used as a dimmer switch. The switch may be mounted on the elongate arm, the vertical support or the base of the lighting device.

The elongate heat sink may have a plurality of elongate channels formed along its length, wherein each of the plurality of elongate channels is separated from an adjacent one of the elongate channels by a respective elongate fin formed along the length of the heat sink. The elongate channels and fins increase the surface area of the heat sink such that the arm of the lighting device functions efficiently as a heat sink. Consequently, to the user, the horizontal arm of the lighting device feels like it has a substantially uniform temperature along its length, and there is no danger of the user burning his- or her-self if they touch the arm close to its first end. The arm consequently functions both as a main support structure which comprises a significant body part of the lighting device, and also a heat sink.

The elongate heat sink may have a channel formed therein which partially or completely surrounds the elongate heat pipe. The arrangement of the heat pipe and heat sink provides a passive cooling system for the light source which is energy efficient, light-weight, has no moving parts, and has high effective thermal conductivity. The heat pipe functions to transfer heat efficiently and evenly away from the light source, and to the heat sink. Heat pipes generally have effective thermal conductivities in the range of from 5000 to 200,000 W/mK.

The heat pipe comprises a hollow, vacuum tight, sealed tubular structure which contains a small quantity of working fluid, such as water, acetone, nitrogen, methanol, ammonia or sodium, and which has a capillary wicking structure in the interior of the heat pipe. Heat from the light source is absorbed by vapourising the working fluid. The vapour then transports heat along the heat pipe to a condenser region where the condensed vapour releases heat to the heat sink which consists of the horizontal arm of the lighting device. The condensed working fluid is then returned to the end of the heat pipe closest to the light source by the wicking structure which lines the inner surface of the heat pipe structure and creates capillary action. The wicking structure may comprise any appropriate structure such as elongate grooves along the length of the inner surface of the heat pipe structure, a screen or wire contained within the hollow heat pipe, or a sintered powder metal contained within the hollow heat pipe. The vacuum contained within the heat pipe causes the working fluid to boil and absorb heat at well below its boiling point at standard atmospheric pressure. For example, water will boil at just above 0° C. and effectively transfer heat at this temperature and above.

The heat sink which consists of the elongate structural arm may be formed from any suitable material such as aluminium, or stainless steel. The elongate heat pipe may be formed from any suitable material such as copper, aluminium, titanium, stainless steel, nickel, tungsten and alloys thereof. The working fluid may be any appropriate fluid for the operating temperature, such as water (which has an operating temperature range of 0° C. to 325° C.), acetone, ammonia, methanol, or pentane.

The elongate arm which forms the heat sink may have a maximum thickness to length aspect ratio in the range of 1:15 to 1:100, more preferably in the range of 1:20 to 1:75, and more preferably in the range of 1:25 to 1:50.

The light source may comprise at least one light emitting diode (LED) which may be mounted on a printed circuit board. In a particular embodiment, the light source comprises a plurality of light emitting diodes (LEDs) mounted on a printed circuit board (PCB). In a particular embodiment, the light source comprises eight LEDs mounted in a line arranged along a portion of the length of the arm.

The light source may be connected to a power cable via a plurality of flat flexible cables. In a particular embodiment, the light source is connected to a first flat flexible cable which runs along at least a portion of the horizontal arm. The first flat flexible cable may be connected to a second flat flexible cable which runs along at least a portion of the vertical support. The first and second flat flexible cables may be connected via a support structure which connects the horizontal arm to the vertical support.

In a second aspect of the invention, which may be used independently from or in combination with any of the features of the first aspect of the invention, there is provided a lighting device comprising:

a vertical support;

an elongate arm connected to the vertical support via a connector; and

a light source mounted on the arm; wherein:
the elongate arm has a length and a first plurality of elongate channels formed along at least a portion of its length, and
the connector comprises a sheet structure having a first plurality of wheels rotatably mounted thereon, wherein each of the first plurality of wheels is arranged and configured to ride along at least one of the first plurality of elongate channels, such that the elongate arm can slide relative to the vertical support in a direction parallel to the length of the arm.

The first plurality of wheels may consist of three wheels, wherein two of the three wheels are rotatably mounted to the sheet structure and ride along a first elongate channel formed in a first surface of the horizontal arm, and the third of the three wheels is rotatably mounted to the sheet structure and rides along a second elongate channel formed in a second surface of the horizontal arm. The first surface may be the top surface of the arm, and the second horizontal surface may be the bottom surface of the arm. Alternatively, the first surface may be the bottom surface of the arm, and the second surface may be the top surface of the arm. The first and second surfaces may be horizontal surfaces.

Each of the three wheels of the first plurality of wheels may be mounted to the sheet structure via a mounting stud or bushing. Two of the three wheels may be mounted concentrically, i.e. with the wheel axis concentric with the axis of its mounting stud or bushing, and the third wheel may be mounted eccentrically, i.e. with the wheel axis slightly offset in the radial direction from the axis of its mounting stud or bushing. The combination of two concentrically mounted wheels and one eccentrically mounted wheel provides for a very smooth operation which compensates for any manufacturing tolerances along the length of the arm.

When the first and second aspects of the present invention are used in combination, the elongate arm forms a heat sink and the first plurality of elongate channels formed along at least a portion of the length of the arm may consist of the plurality of elongate channels which are separated by the elongate fins.

The vertical support may comprise an elongate support having a length and a second plurality of elongate channels formed along at least a portion of its length. The sheet structure of the connector may have a second plurality of wheels rotatably mounted thereon, wherein each of the second plurality of wheels is arranged and configured to ride along at least one of the second plurality of elongate channels, such that the elongate arm can slide relative to the vertical support in a direction parallel to the length of the vertical support.

The first plurality of wheels may be mounted on a first side of the sheet structure, and the second plurality of wheels may be mounted on a second side of the sheet structure which is opposite to the first side.

The second plurality of wheels may consist of three wheels, wherein two of the three wheels are rotatably mounted to the sheet structure and ride along a first elongate channel formed in a first vertical surface of the vertical support, and the third of the three wheels is rotatably mounted to the sheet structure and rides along a second elongate channel formed in a second vertical surface of the vertical support. The first vertical surface may be on an opposite side of the vertical support to the second vertical surface.

Each of the three wheels of the second plurality of wheels may be mounted to the sheet structure via a mounting stud or bushing. Two of the three wheels may be mounted concentrically, i.e. with the wheel axis concentric with the axis of its mounting stud or bushing, and the third wheel may be mounted eccentrically, i.e. with the wheel axis slightly offset in the radial direction from the axis of its mounting stud or bushing. The combination of two concentrically mounted wheels and one eccentrically mounted wheel provides for a very smooth operation which compensates for any manufacturing tolerances along the length of the vertical support.

In a particular embodiment the elongate arm comprises a horizontal elongate arm. The vertical support may be mounted on a base. The vertical support may be elongated such that its length is significantly larger than its maximum thickness. The vertical support may be connected to the base via a jack plug which allows for unlimited rotation of the vertical support relative to the base whilst also providing for an electrical connection between the light source and an electrical connector which is mounted in or on the base and is connectable to a power source.

The light source may be mounted close to a first end of the elongate arm. Alternatively, the light source may be mounted close to a centre of the arm.

The lighting device may further comprise at least one switch for turning the light source on and off. The at least one switch may also be used as a dimmer switch. The switch may be mounted on the elongate arm, the vertical support or the base of the lighting device.

The light source may comprise at least one light emitting diode (LED) which may be mounted on a printed circuit board. In a particular embodiment, the light source comprises a plurality of light emitting diodes (LEDs) mounted on a printed circuit board (PCB). In a particular embodiment, the light source comprises eight LEDs mounted in a line arranged along a portion of the length of the arm.

The light source may be connected to a power cable via a plurality of flat flexible cables. In a particular embodiment, the light source is connected to a first end of a first flat flexible cable which runs along at least a portion of the elongate arm. A second end of the first flat flexible cable is connected to a first electrical contact positioned on a first side of the sheet structure of the connector. The first electrical contact is connected to a second electrical contact on an opposite side of the sheet structure of the connector. The second electrical contact is connected to a first end of a second flat flexible cable which runs along at least a portion of the vertical support. A second end of the second flat flexible cable is electrically connectable to a power supply either directly or via one or more further cables.

In a third aspect of the invention, which may be used independently from or in combination with any of the features of the first and or second aspects of the invention, there is provided a lighting device comprising:

a vertical support;

an arm connected to the vertical support via a first connector;

a light source mounted on the arm and electrically connected to the first connector;

a counterweight connected to a first pulley wheel;

a second electrical connector mounted in a fixed position close to an upper end of the vertical support, wherein the second electrical connector is connectable to a power source;

a second pulley wheel rotatably mounted in a fixed position close to an upper end of the vertical support and above the second electrical connecter; and

a first flexible flat power cable which runs along at least a portion of the vertical support, wherein the first power cable has a first end electrically connected to the first connector, and a second end electrically connected to the second electrical connector, wherein the first power cable is arranged to pass over an upper portion of the second pulley and under a lower portion of the first pulley, such that movement of the arm and first connector in a vertical direction causes movement of the counterweight in an opposite vertical direction.

The lighting device may further comprise a second power cable which runs along at least a portion of the vertical support, the second power cable having a first end which is connected to a plug that is electrically connectable to a power source, and a second end which is connected to, or forms, the second electrical connector.

The first end of the second cable may be connected to a jack plug positioned at a lower end of the vertical support. The vertical support may be connected to a base. In a particular embodiment, the vertical support may be connected to a base via the jack plug such that the jack plug allows for unlimited rotation of the vertical support relative to the base whilst also providing for an electrical connection between the second cable and an electrical connector which is mounted in or on the base and is connectable to a power source.

The lighting device may further comprise a third power cable which runs along at least a portion of the arm and is electrically connected to the first connector and the light source.

The counterweight may be weighted relative to a total weight of the arm, light source, first power cable, first connector and any other components mounted on the arm, such that the counterweight and arm are balanced relative to one another and neither the arm nor the counterweight moves unless an external force is applied to the arm or the counterweight. In a particular embodiment, the counterweight may be double the total weight of the arm and any other components mounted on the arm, such that the counterweight moves half the distance of the arm. The counterweight may be an elongate counter weight having a width substantially the same as a width of the vertical support such that the counterweight can slide up and down a side of the vertical support. The counterweight may include lugs which are arranged to slide within an elongate channel formed in a side of the vertical support.

The arm may comprise an elongate horizontal arm. The vertical support may be elongated such that its length is significantly larger than its maximum thickness.

The light source may be mounted close to a first end of the elongate arm. Alternatively, the light source may be mounted close to a centre of the arm.

The lighting device may further comprise at least one switch for turning the light source on and off. The at least one switch may also be used as a dimmer switch. The switch may be mounted on the elongate arm, the vertical support or the base of the lighting device.

The light source may comprise at least one light emitting diode (LED) which may be mounted on a printed circuit board. In a particular embodiment, the light source comprises a plurality of light emitting diodes (LEDs) mounted on a printed circuit board (PCB). In a particular embodiment, the light source comprises eight LEDs mounted in a line arranged along a portion of the length of the arm.

In a fourth aspect of the invention, which may be used independently from or in combination with any of the features of the first, second and/or third aspects of the invention, there is provided a lighting device comprising:

a plurality of light emitting diodes, each light emitting diode including an integral lens, wherein each of the light emitting diodes is mounted with its lens pointing in the same direction; and

a plurality of frustoconical surfaces, each of the frustoconical surfaces being bounded by a first opening and a second opening wider than the first opening, wherein each of the light emitting diodes is mounted such that its lens is positioned within the first opening of a corresponding one of the frustoconical surfaces.

The arrangement of the light emitting diodes and the frustoconical surfaces ensures that the light emitted from the lighting device is substantially constant over a wide area so that it has no spots or rings of higher or lower intensity. The frustoconical surfaces also act as shades of the light emitting diodes so that a user cannot see the diodes directly, without deliberately looking up at the diodes from below. The frustonical surfaces also mean that there is no need for any complicated lensing structure in order to provide a constant illumination over a wide area.

Each light emitting diode has an axis along which a maximum intensity of light is emitted, and each light emitting diode may be arranged so that its axis is aligned with the axis of rotation of a respective frustoconical surface.

The plurality of frustoconical surfaces may be formed such that their second openings are formed within a single flat surface. In addition, each frustoconical surface may be positioned such that its second opening meets a second opening of an adjacent frustoconical surface at a point. The plurality of light emitting diodes may be arranged in a straight line with their axes parallel to one another, and the plurality of frustoconical surfaces may be aligned in a straight line with their axes of rotation aligned parallel to one another.

The plurality of light emitting diodes (LEDs) may be mounted on a printed circuit board (PCB).

The single flat surface may be a first surface of a single moulded or machined component.

When the single flat surface is a first surface of a single moulded or machined component, the printed circuit board may be connected to a second surface of the single moulded or machined component opposite to the first surface to form a modular component.

The modular component may be mounted to the arm of the lighting device of any of the first to third aspects of the present invention, in order to provide the recited light source.

In connection with a combination of the first and fourth aspects of the present invention, the heat pipe may be positioned so that one of its ends is in thermal contact with the printed circuit board on which the plurality of LEDs are mounted. The heat pipe may be joined to the printed circuit board using a thermally conductive adhesive.

### BRIEF DESCRIPTION OF THE FIGURES

Aspects of the present invention will now be described with reference to the figures in which:

FIGS. 1(a) to 1(e) show front, right, back, front perspective and back perspective views, respectively, of a lighting device according to a first embodiment of the present invention;

FIGS. 2(a) to 2(f) show front, back, right, left, front perspective and back perspective views, respectively, of a lighting device according to a second embodiment of the present invention;

FIGS. 3(a) to 3(d) show top, side, bottom and end views respectively of an elongate arm, heat pipe and light source according to both the first and second embodiments of the present invention;

FIG. 3(e) shows a cross section of the elongate arm and heat pipe taken along line D-D in FIG. 3(b);

FIGS. 4(a) to 4(c) show top, side and bottom views respectively of the arrangement of FIGS. 3(a) to 3(e), and further shows an additional modular component and cover for the light source end of the elongate arm;

FIG. 5 shows detail of the interaction between parts of a connector and an elongate arm according to the first and second embodiments of the present invention;

FIGS. 6(a) to 6(d) show front, side, cut-away side, and front perspective views respectively of the vertical support, connector and pulley mechanism according to the second embodiment of the present invention. FIG. 6(c) shows a cut-away view along line C-C in FIG. 6(a);

FIGS. 7(a) to 7(d) show front, side, cut-away side, and front perspective views respectively of the connector and pulley mechanism according to both the first and second embodiments of the present invention. FIG. 7(c) shows a cut-away view along line C-C in FIG. 7(a);

FIGS. 8(a) to 8(f) show bottom perspective, top perspective, bottom, side, top, and cut-away side views respectively of the modular component comprising the light source of the first and second embodiments of the present invention. FIG. 8(f) shows a cut-away view along line A-A in FIG. 7(e);

FIGS. 9(a) to 9(c) shows bottom perspective, bottom and side views respectively of the printed circuit board and light emitting diodes shown in the modular component of FIGS. 8(a) to 8(f); and

FIGS. 10(a) to 10(f) show bottom perspective, top perspective, bottom, side, top and cut-way side views respectively of the modular component of FIGS. 8(a) to 8(f) when connected to the elongate arm and heat pipe according to both the first and second embodiments of the present invention. FIG. 10(f) shows a cut-away view along line A-A in FIG. 10(e).

### DETAILED DESCRIPTION OF THE FIGURES

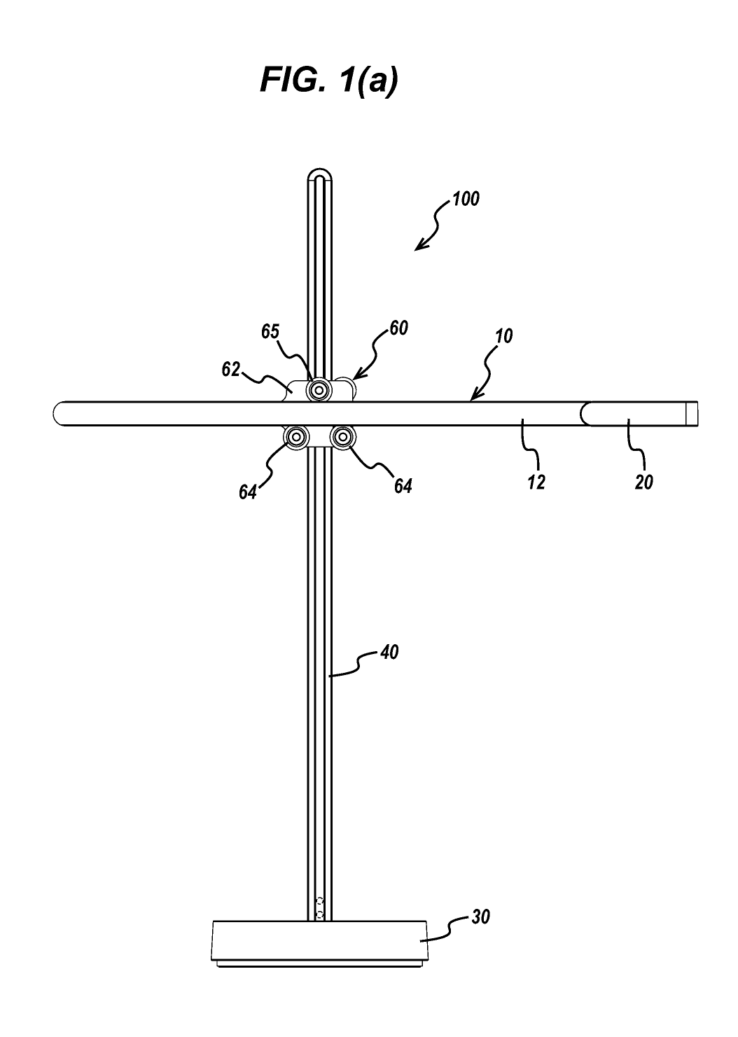

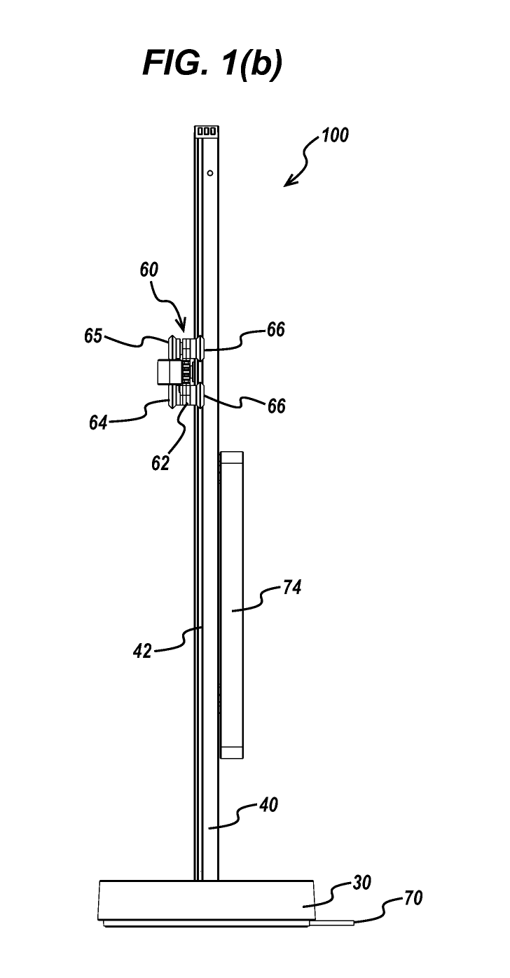

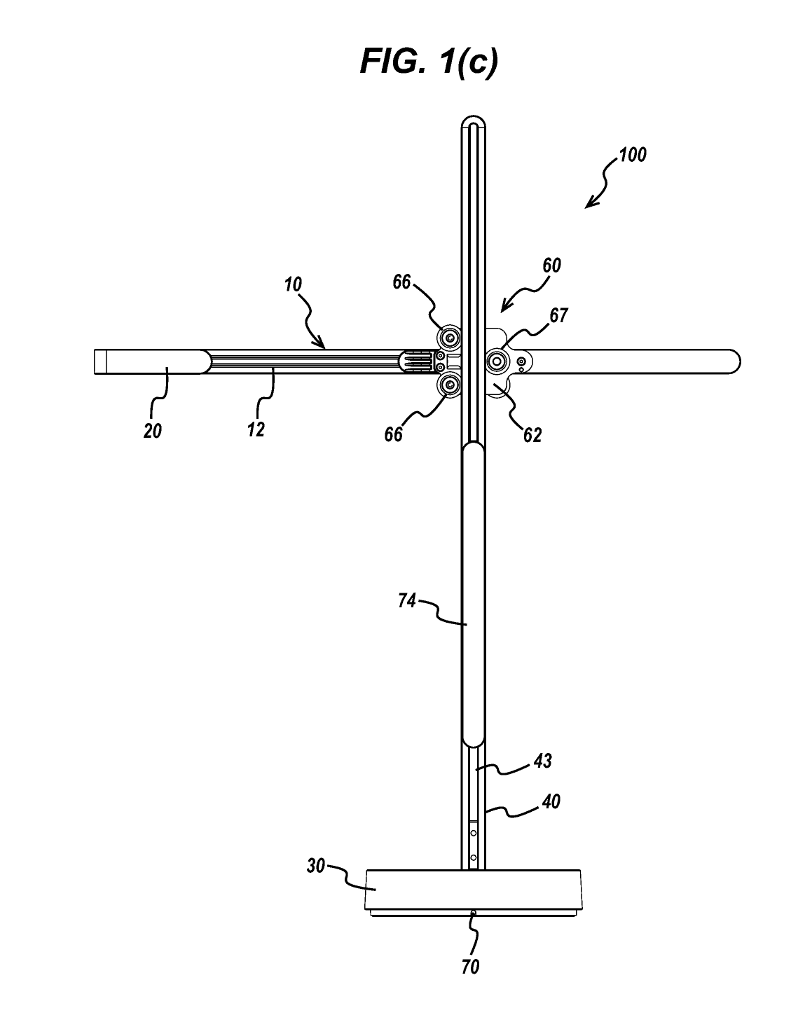

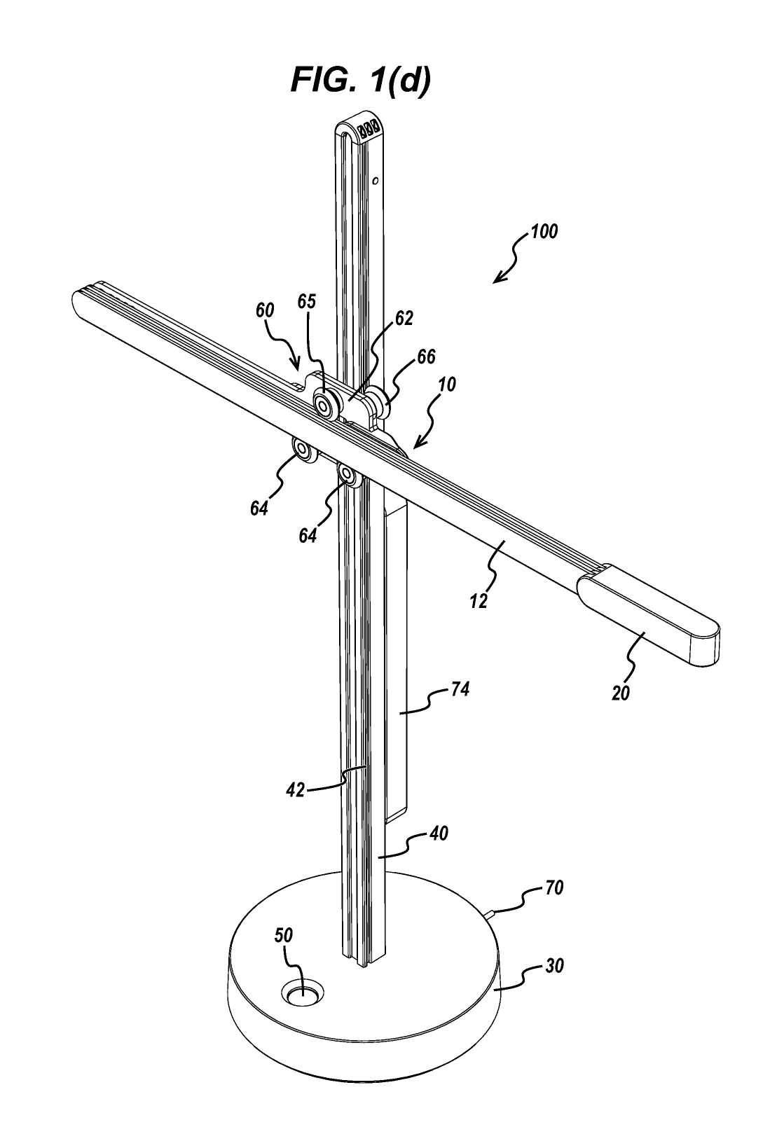

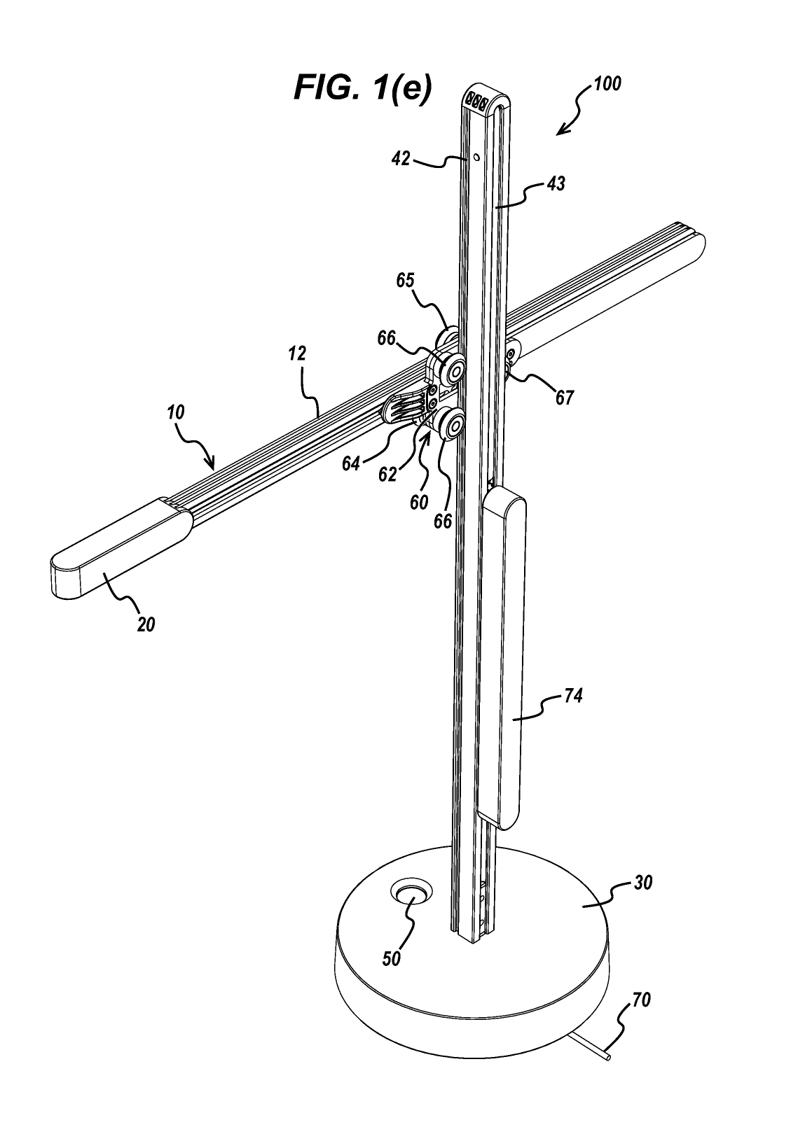

FIGS. 1(a) to 1(e) show various views of a desk lamp 100 which is a lighting device according to a first embodiment of the present invention.

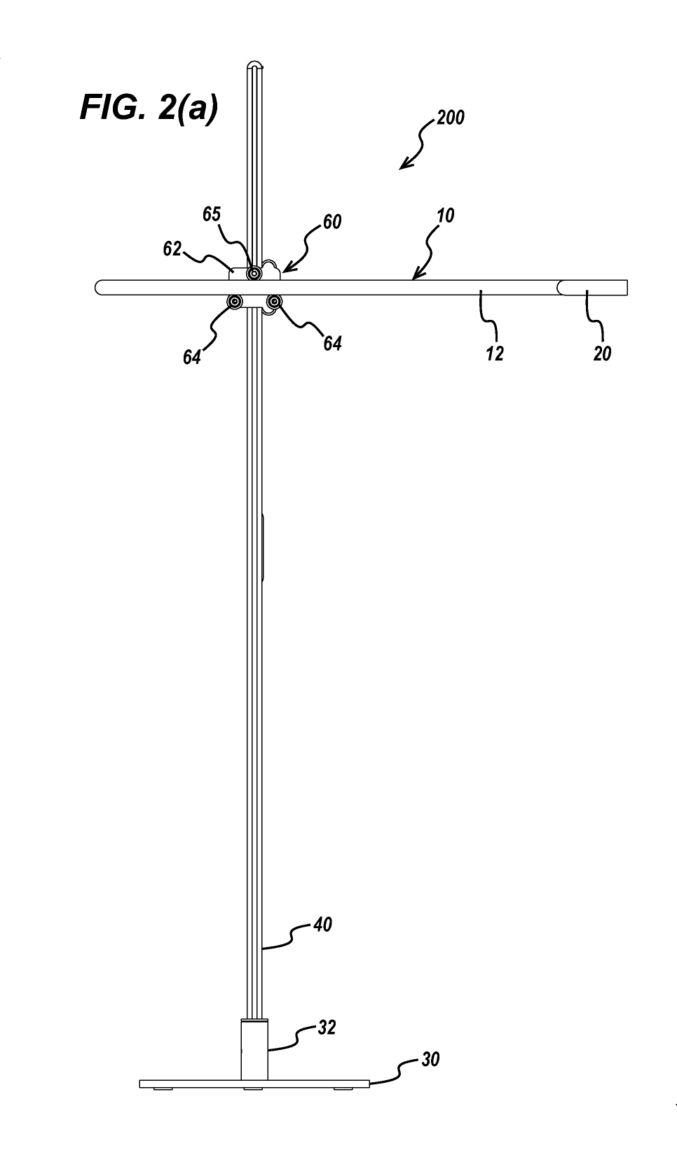

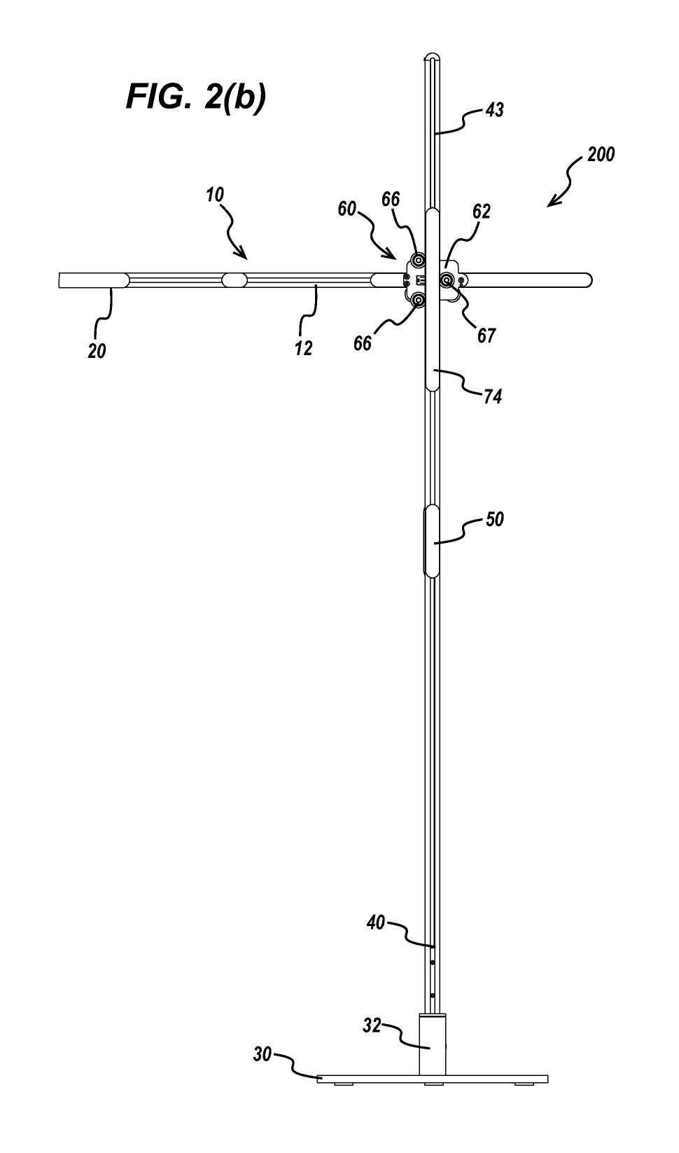

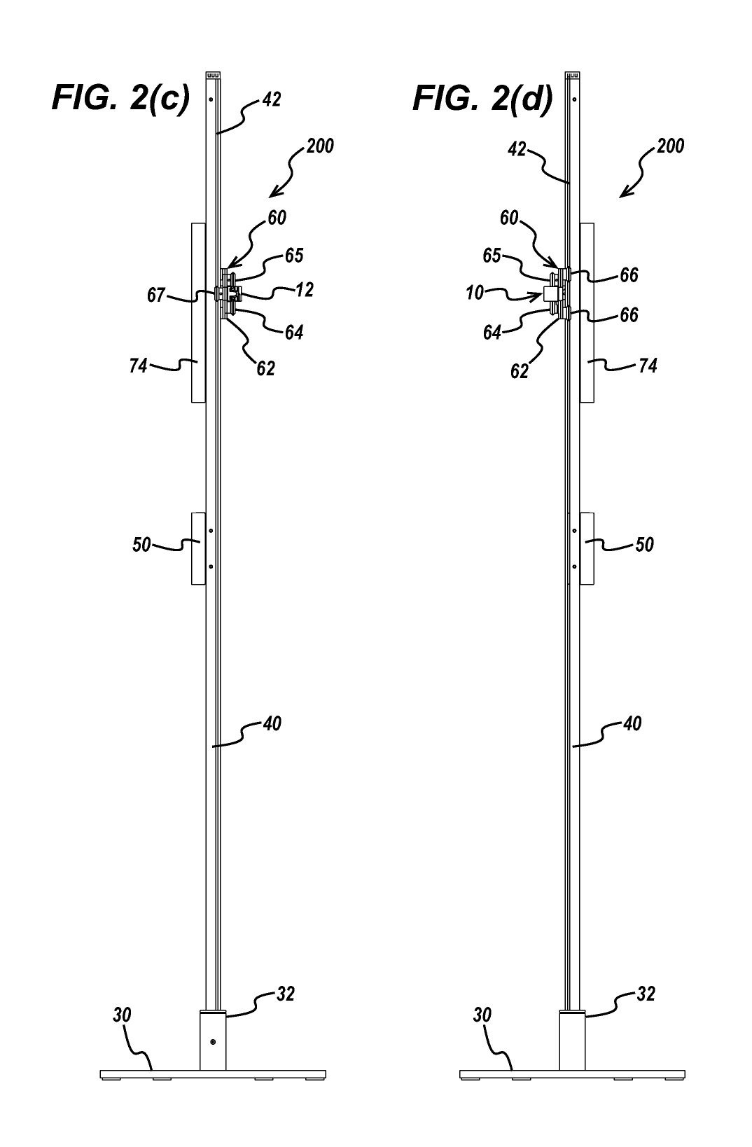

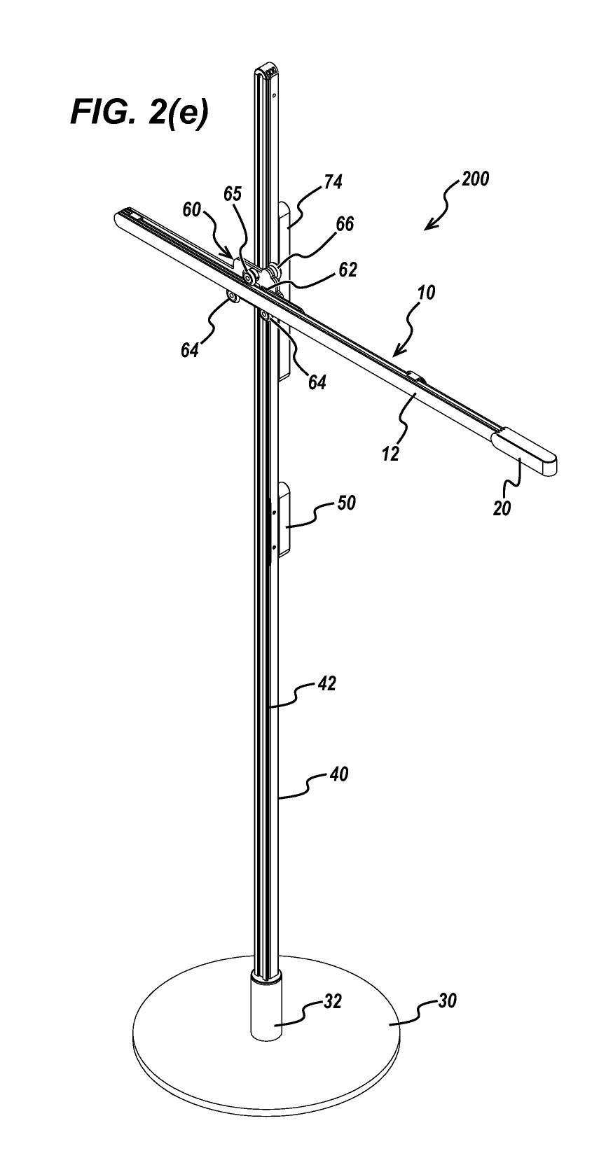

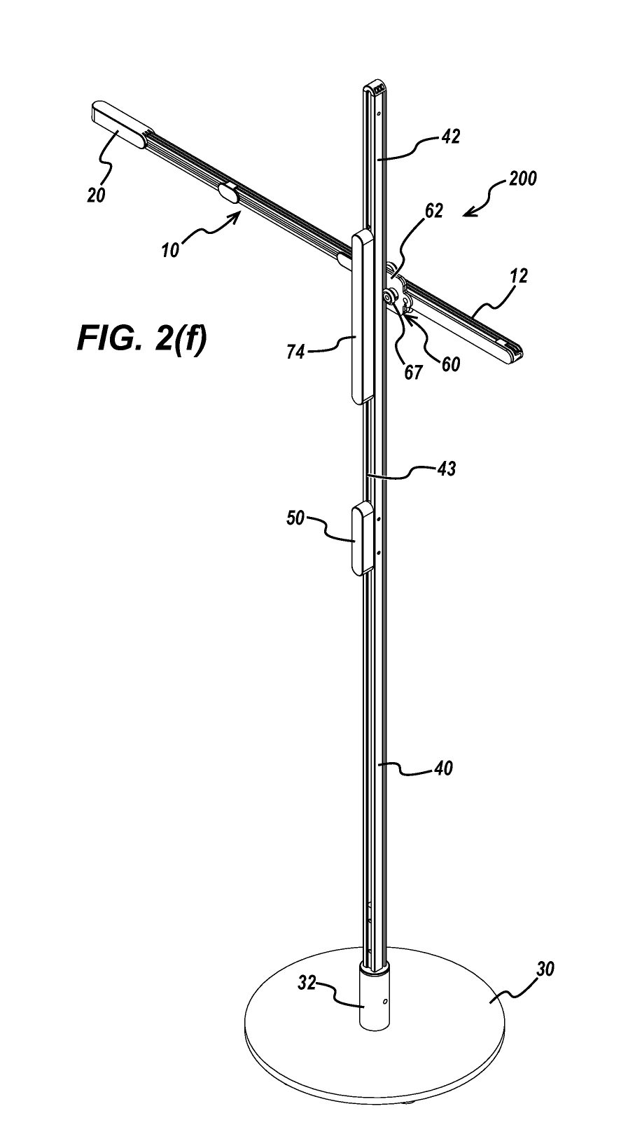

FIGS. 2(a) to 2(e) show various views of a floor-standing lamp 200 which is a lighting device according a second embodiment of the present invention.

The lamps 100, 200 have many features in common. Where differences exist, these will be clear from the following description. However, the majority of the following detailed description relates to both the first and second embodiments shown in FIGS. 1 and 2.

Both lamp 100 and lamp 200 include a horizontal arm 10. The arm 10 is elongated such that its length is significantly larger than its maximum thickness. A light source 20 is mounted on a first end of the arm 10. The horizontal elongate arm 10 consists essentially of, an elongate heat sink 12, and an elongate heat pipe 14 is positioned within the heat sink 12 and in thermal contact with the light source 20.

Lamps 100, 200 each further comprise a base 30 and a vertical support 40 mounted on the base 30. The elongate arm 20 is mounted on the vertical support 40. The vertical support 40 is elongated such that its length is significantly larger than its maximum thickness.

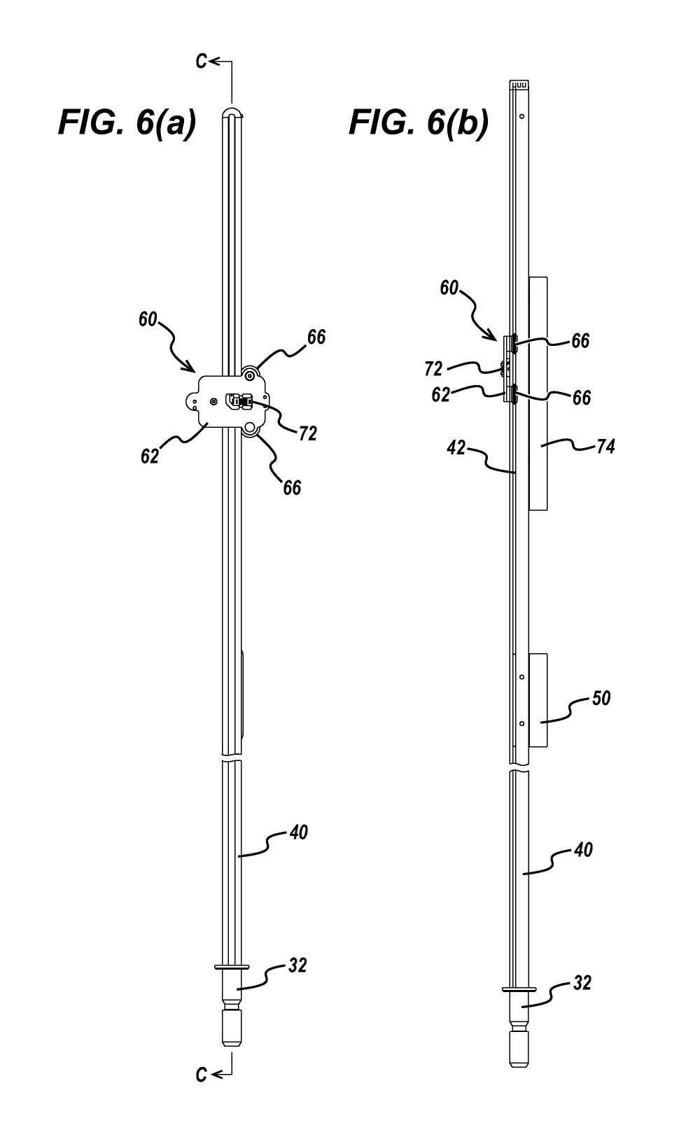

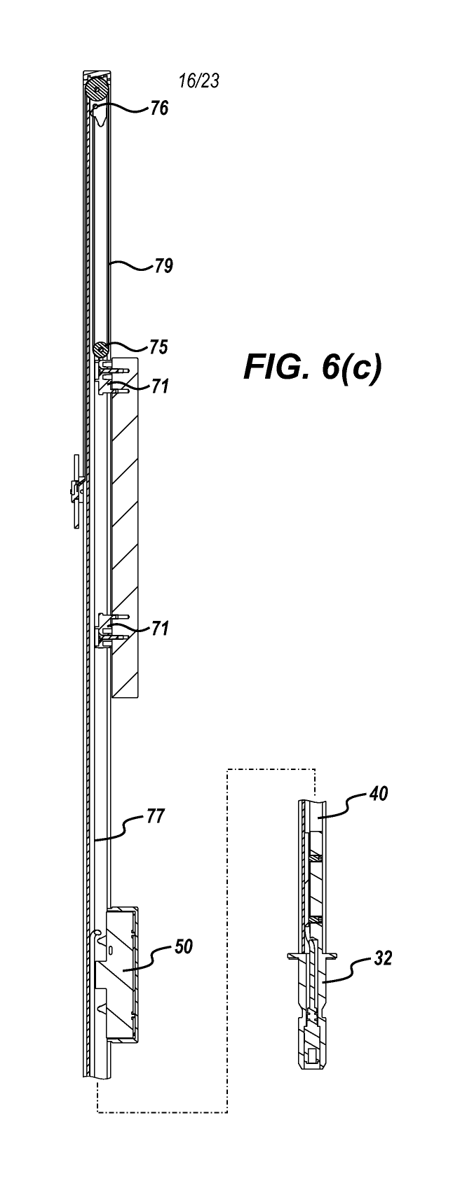

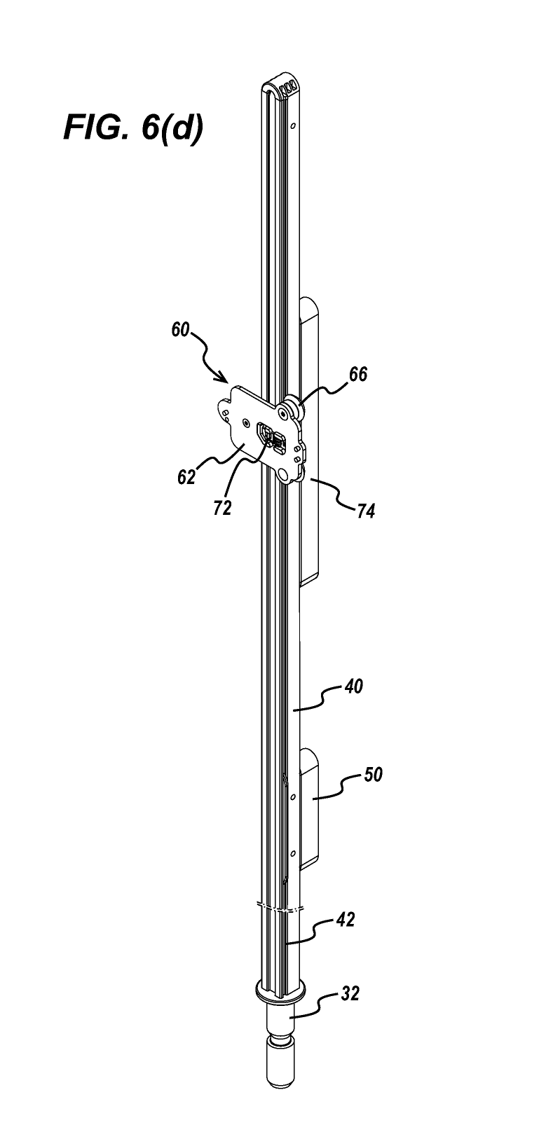

In both embodiments, although only shown in FIGS. 2 and 6 relating to the second embodiment, the vertical support 40 is connected to the base 30 via a jack plug 32 which allows for unlimited rotation of the vertical support 40 relative to the base 30 whilst also providing for an electrical connection between the light source 20 and an electrical connector (not shown) which is mounted in or on the base 40 and is connectable to a power source.

The lamps 100, 200 each further comprise a switch 50 for turning the light source on and off, and also for acting as a dimmer to change the brightness of the light. In the first embodiment of lamp 100, the switch 50 is mounted on the base 30. In the second embodiment of lamp 200, the switch 50 is mounted on the vertical support 40.

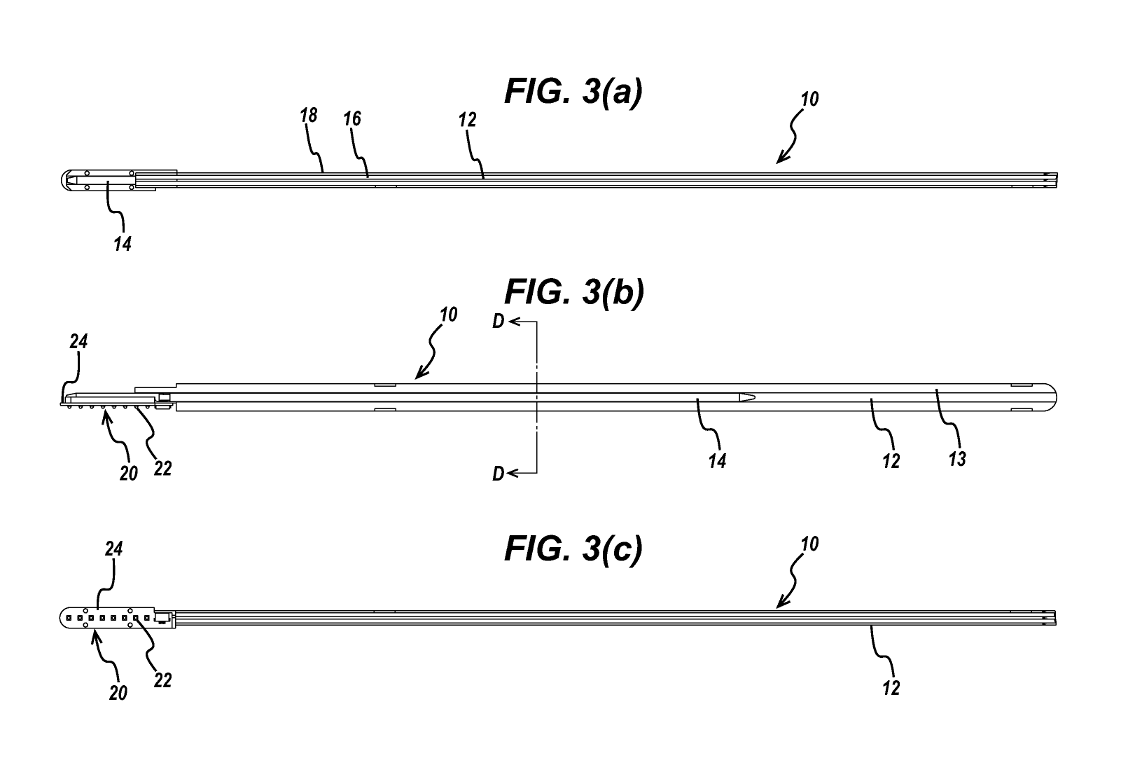

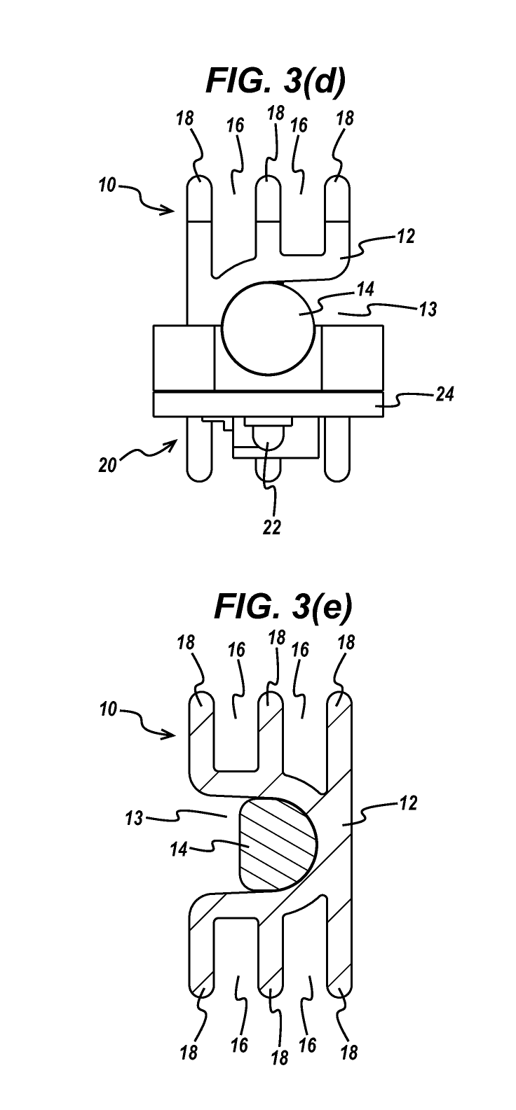

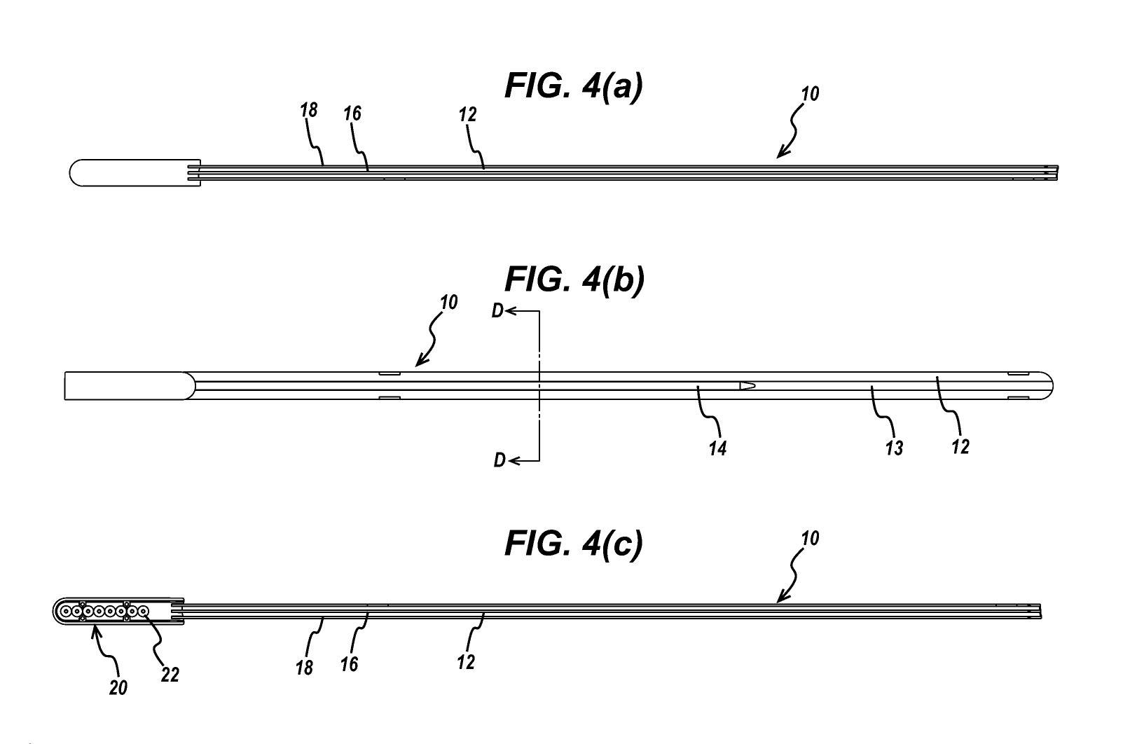

As is best seen in FIGS. 3, 4, 5 and 10, the elongate heat sink 12 has a plurality of elongate channels 16 formed along its length. Each of the plurality of elongate channels 16 is separated from an adjacent one of the elongate channels 16 by a respective elongate fin 18 formed along the length of the heat sink 12. The elongate channels 16 and fins 18 increase the surface area of the heat sink 12 such that the arm 10 of the lamp 100, 200 functions efficiently as a heat sink. When in use, the horizontal arm 10 of the lamp 100, 200 feels like it has a substantially uniform temperature along its length, and there is no danger of the user burning his- or her-self if they touch the arm 10 close to the first end where the light source 20 is positioned. The arm 10 consequently functions both as a main support structure which comprises a significant body part of the lamp 100, 200, and also as a heat sink.

As best seen from FIGS. 3, 4 and 5, the elongate heat sink 12 has a channel 13 formed therein which partially surrounds the elongate heat pipe 14. The arrangement of the heat pipe 14 and heat sink 12 provides a passive cooling system for the light source 20. The heat pipe 14 functions to transfer heat efficiently and evenly away from the light source 20, and to the heat sink 12.

The heat pipe 14 comprises a hollow, vacuum tight, sealed tubular structure which contains a small quantity of a working fluid, and which has a capillary wicking structure (not shown) in its interior. Heat from the light source 20 is absorbed by vapourising the working fluid. The vapour then transports heat along the heat pipe 14 away from the light source 20 to a region where the condensed vapour releases heat to the heat sink 12. The condensed working fluid then returns to the end of the heat pipe 14 closest to the light source 20 by means of the wicking structure.

In the embodiments shown, the heat sink 12 is formed from aluminium, and the heat pipe 14 is formed from copper.

The heat sink 12 has a maximum thickness to length aspect ratio of approximately 1:25 in the first embodiment and approximately 1:34 in the second embodiment.

As is best seen from FIGS. 1, 2, 5, 6 and 7, the elongate horizontal arm 10 is connected to the vertical support 40 via a connector 60. The connector 60 comprises a sheet structure 62 having three first wheels 64, 65 rotatably mounted thereon. Each of the three first wheels 64, 65 is arranged and configured to ride along one of the elongate channels 16 in the elongate arm 10, such that the elongate arm 10 can slide relative to the vertical support 40 in a direction parallel to the length of the arm 10. Two of the three first wheels 64 are rotatably mounted to the sheet structure 62 and ride along a first elongate channel 16 formed in a lower surface of the horizontal arm 10, and the third of the three first wheels 65 is rotatably mounted to the sheet structure 62 and rides along a second elongate channel 16 formed in an upper surface of the horizontal arm 10.

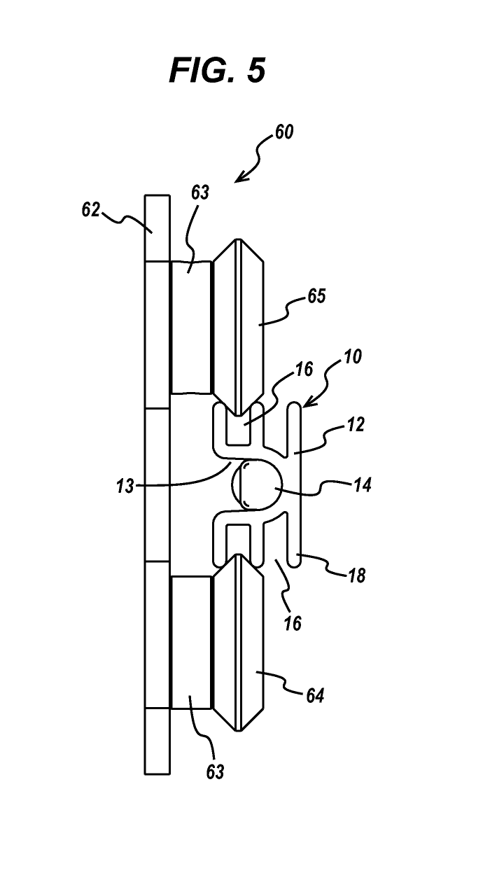

As is best seen from FIG. 5, each of the three first wheels 64, 65 is mounted to the sheet structure 62 via a mounting stud or bushing 63. Two of the three first wheels 64, 65 are mounted concentrically so that their wheel axis is concentric with the axis of its mounting stud or bushing 63, and a third of the first wheels 64, 65 is mounted eccentrically, so that its wheel axis is slightly offset in the radial direction from the axis of its mounting stud or bushing 63. The combination of two concentrically mounted wheels 64, 65 and one eccentrically mounted wheel 64, 65 provides for a very smooth operation which compensates for any manufacturing tolerances along the length of the arm 10.

The vertical support 40 comprises an elongate support having a length and a second plurality of elongate channels 42 formed along its length. The sheet structure 62 of the connector 60 has three second wheels 66, 67 rotatably mounted thereon. Each of the second wheels 66, 67 is arranged and configured to ride along one of the second plurality of elongate channels 42, such that the elongate arm 10 can slide relative to the vertical support 40 in a direction parallel to the length of the vertical support 40.

The three first wheels 64, 65 are mounted on a first side of the sheet structure 62, and the three second wheels 66, 67 are mounted on a second side of the sheet structure 62 which is opposite to the first side.

Two of the three second wheels 66 are rotatably mounted to the sheet structure 62 and ride along a first elongate channel 42 formed in a first vertical surface of the vertical support 40, and the third of the second wheels 67 is rotatably mounted to the sheet structure 62 and rides along a second elongate channel 42 formed in a second vertical surface of the vertical support 40 which is on an opposite side of the vertical support 40 to the first vertical surface.

Each of the three second wheels 66, 67 is mounted to the sheet structure 62 via a mounting stud or bushing. Two of the three second wheels 66, 67 are mounted with their wheel axis concentric with the axis of their mounting stud or bushing, and the third of the second wheels 66, 67 is mounted with its wheel axis slightly offset in the radial direction from the axis of its mounting stud or bushing. The combination of the two concentrically mounted wheels 66, 67 and one eccentrically mounted wheel 66, 67 provides for a very smooth operation which compensates for any manufacturing tolerances along the length of the vertical support 40.

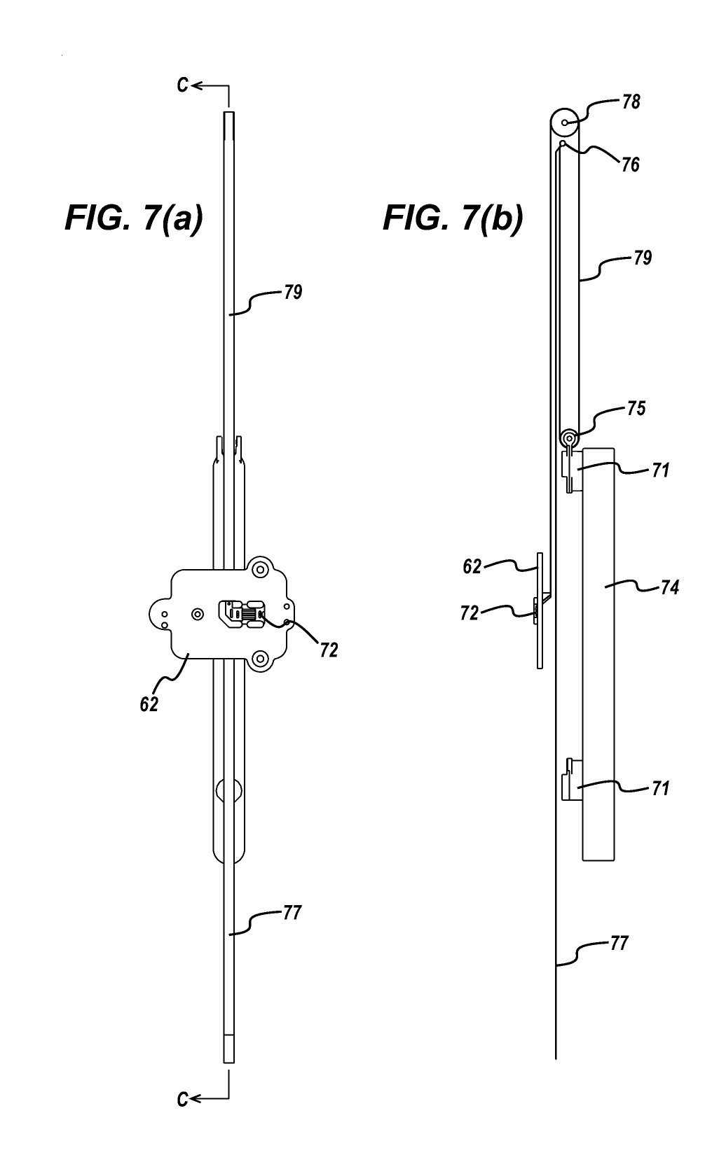

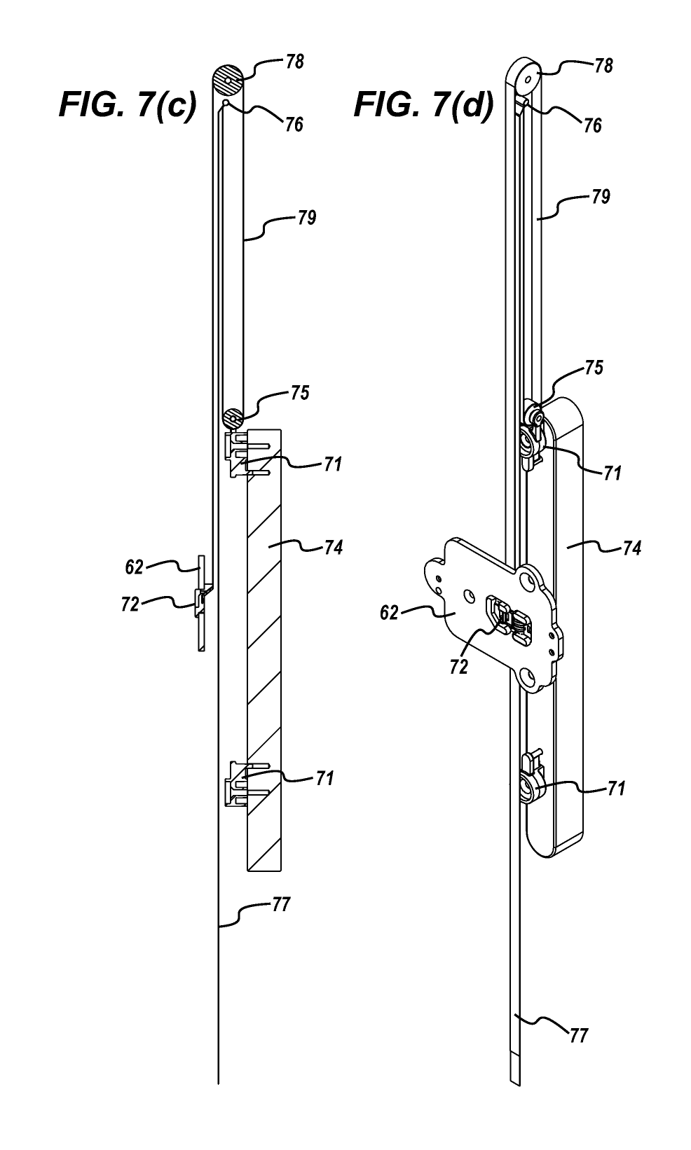

The light source 20 is electrically connected to a first electrical connector 72 positioned on the sheet structure 62 via a flexible flat cable (not shown) which runs along the arm 10. As is best seen from FIGS. 1, 2, 6 and 7, the lamps 100, 200 are provided with a counterweight 74. The counterweight 74 is connected to a first pulley wheel 75. As shown in FIG. 7, a second electrical connector 76 is mounted in a fixed position close to an upper end of the vertical support 40. The second electrical connector 76 is connectable to a power source via a power cable 70 (shown in FIG. 1) and a further flexible flat cable 77 which runs along a portion of the vertical support 40 (shown in FIGS. 6 and 7). The further flexible flat cable 77 has a first end which is connected to the second electrical connector 76 and, in the second embodiment shown in FIG. 6, a second end that is connected to the jack plug 32. The jack plug 32 is electrically connectable to a power source via a power cable within the base 30.

As shown in FIGS. 6 and 7, a second pulley wheel 78 is rotatably mounted in a fixed position close to an upper end of the vertical support 40 and above the second electrical connecter 76. A flexible flat power cable 79 runs along a portion of the vertical support 40. The flexible flat power cable 79 has a first end electrically connected to the first connector 72, and a second end electrically connected to the second electrical connector 76, and is arranged to pass over an upper portion of the second pulley 78 and under a lower portion of the first pulley 75, such that movement of the arm 10 and connector 60 in a vertical direction causes movement of the counterweight 74 in an opposite vertical direction.

The counterweight 74 is weighted relative to the total weight of the arm 10, light source 20, first power cable, connector 60 and any other components mounted on the arm 10, such that the counterweight 74 and arm 10 are balanced relative to one another and neither the arm 10 nor the counterweight 74 moves unless an external force is applied to the arm 10 or the counterweight 74. In particular, with the arrangement shown, the counterweight is double the total weight of the arm and any other components mounted on the arm, such that the counterweight moves half the distance of the arm. The counterweight 74 is an elongate counterweight with a width that is substantially the same as the width of the vertical support 40. The counterweight 74 can slide up and down a side of the vertical support 40. The counterweight 74 include lugs 71 which are arranged to slide within an elongate channel 43 formed in a side of the vertical support 40.

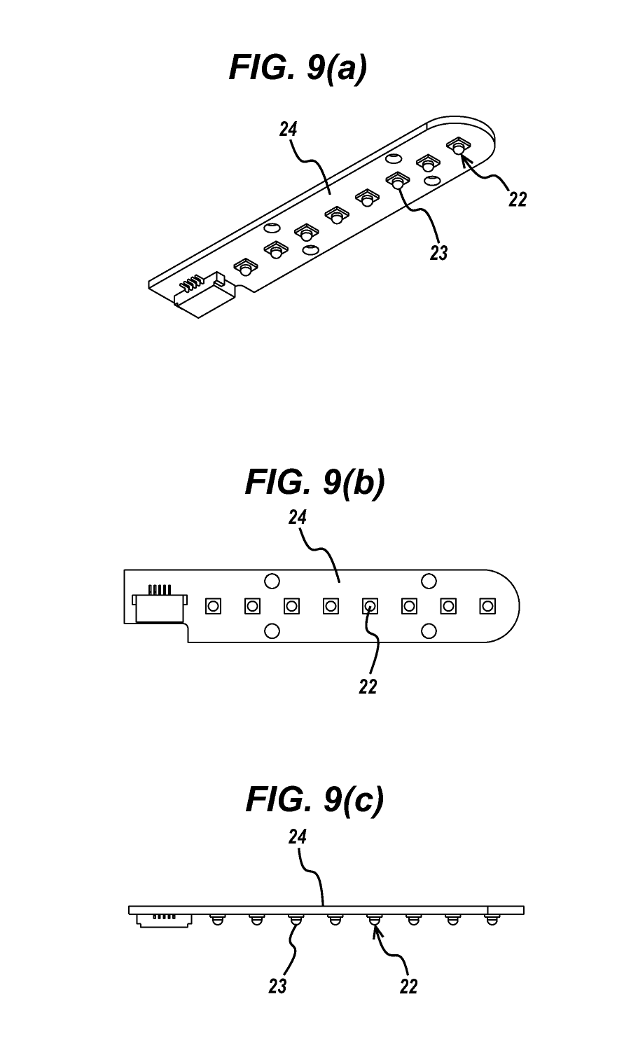

As is best seen from FIGS. 3, 8 and 9, the light source 20 comprises a plurality of LEDs 22 mounted on a printed circuit board (PCB) 24. In both embodiments, the light source comprises eight LEDs 22 mounted in a straight line close to the first end of the arm 10.

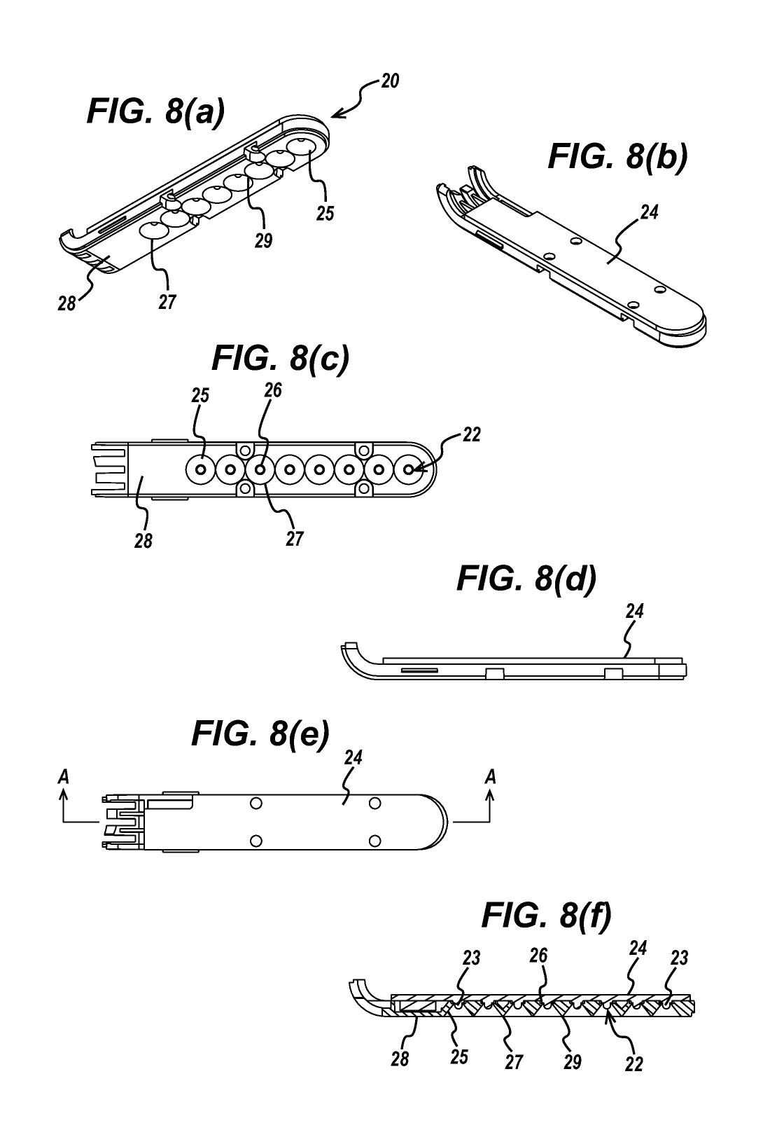

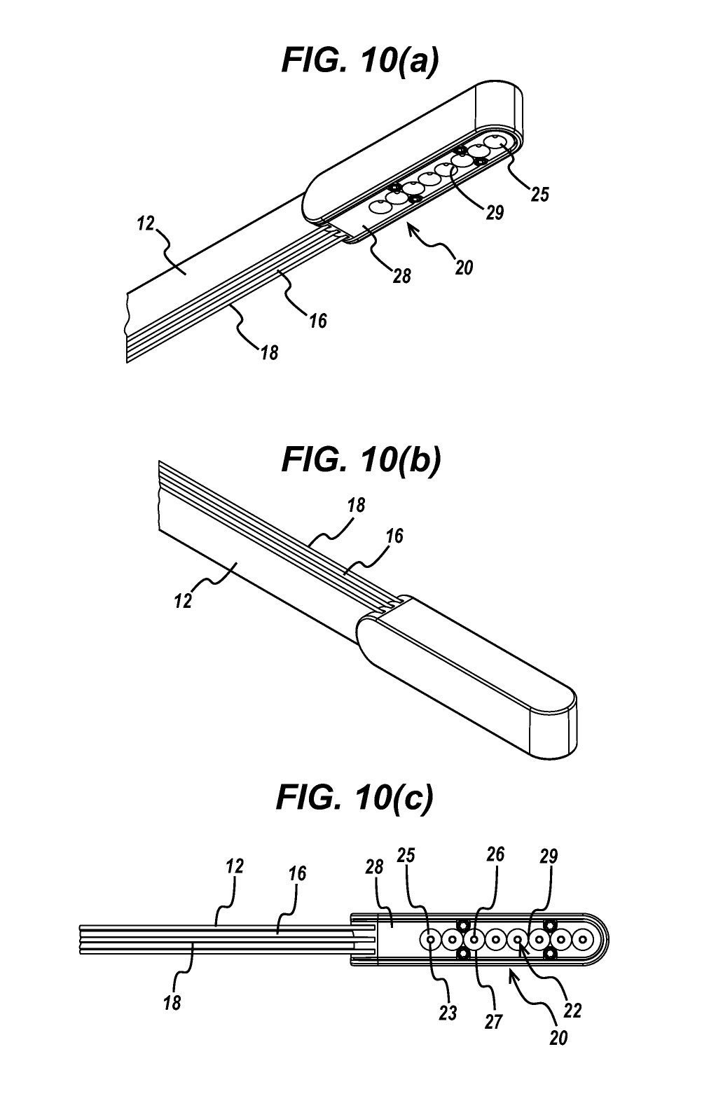

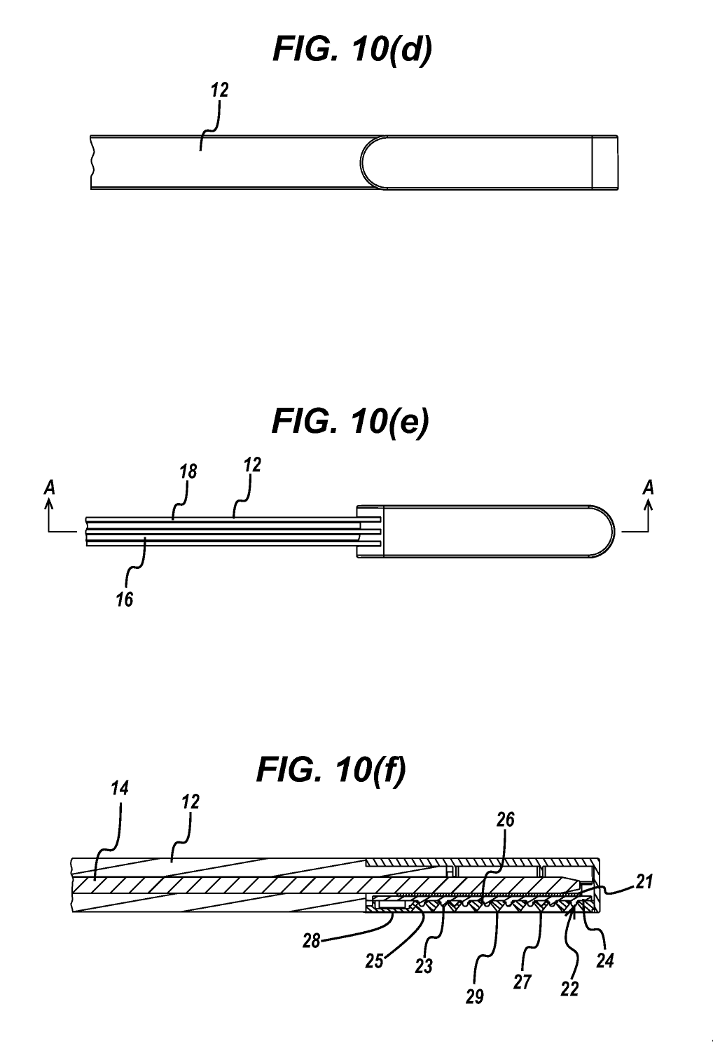

Each LED 22 includes an integral lens 23, and each of the LEDs 22 is mounted with its lens 23 pointing in the same direction. As can be seen from FIGS. 8 and 10, the light source 20 further includes a plurality of frustoconical surfaces 25, each of the frustoconical surfaces 25 being bounded by a first opening 26 and a second opening 27 that is wider than the first opening 26. Each LED 22 is mounted so that its lens 23 is positioned within the first opening 26 of a corresponding frustoconical surface 25.

The arrangement of the LEDs 22 and the frustoconical surfaces 25 ensures that the light emitted from the lamps 100, 200 is substantially constant over a wide area so that it has no spots or rings of higher or lower intensity. The frustoconical surfaces 25 also act as shades for the LEDs 22 so that a user cannot see the diodes 22 directly, without deliberately looking up at the diodes from below. The frustonical surfaces 25 also mean that there is no need for any complicated lensing structure in order to provide a constant illumination over a wide area.

Each LED 22 emits light of a maximum intensity along its axis, and each LED is arranged so that its axis is aligned with the axis of rotation of the respective frustoconical surface 25.

The frustoconical surfaces 25 are formed so that their second openings 26 are formed within a single flat surface 28 The single flat surface 28 is a first surface of a single moulded or machined component which is connected to an end of the elongate arm 10. The printed circuit board 24 is connected to a second opposite surface of the single moulded or machined component to form a modular component.

In addition, each frustoconical surface 25 is positioned so that its second opening 27 meets a second opening 27 of an adjacent frustoconical surface 25 at a point 29. The LEDs 22 are arranged in a straight line with their axes parallel to one another, and the frustoconical surfaces 25 are aligned in a straight line with their axes of rotation aligned parallel to one another.

As is best seen from FIG. 10, the heat pipe 14 is positioned so that one of its ends is in thermal contact with the PCB 24 on which the plurality of LEDs 22 are mounted. The heat pipe 14 is joined to the printed circuit board 24 using a thermally conductive adhesive 21.

Although the invention has been described in detail above, it is expressly understood that it will be apparent to persons skilled in the art that the invention may be modified without departing from the scope of the invention as defined by the claims. Various changes of form, design, or arrangement may be made to the invention without departing from the scope of the invention. Therefore, the above detailed description is to be considered exemplary rather than limiting and the true scope of the invention is that defined by the following claims.

1. A lighting device comprising:
an elongate arm; and
a light source mounted on the arm, wherein
the elongate arm consists of, or consists essentially of, an elongate heat sink; and further comprising:
an elongate heat pipe positioned within the heat sink and in thermal contact with the light source.

2. The lighting device of claim 1, wherein the elongate arm comprises an elongate horizontal arm.

3. The lighting device of claim 1, wherein the light source is mounted close to a first end of the arm, or close to a centre of the arm.

4. The lighting device of claim 1, further comprising a base and a vertical support mounted on the base, wherein the elongate arm is mounted on the vertical support.

5. The lighting device of claim 4, wherein the vertical support is elongated.

6. The lighting device of claim 4, wherein the vertical support is connected to the base via a jack plug.

7. The lighting device of claim 1, wherein the elongate heat sink has a plurality of elongate channels formed along at least a portion of its length, wherein each of the plurality of elongate channels is separated from an adjacent one of the elongate channels by a respective elongate fin formed along at least a portion of the length of the heat sink.

8. The lighting device of claim 1, wherein the elongate heat sink has a channel formed therein which partially or completely surrounds the elongate heat pipe.

9. The lighting device of claim 1, wherein the heat pipe comprises a hollow, vacuum tight, sealed tubular structure which contains a small quantity of a working fluid.

10. The lighting device of claim 1, wherein the elongate arm has a maximum thickness to length aspect ratio in the range of 1:15 to 1:100.

11. The lighting device of claim 1, wherein the light source comprises a plurality of light emitting diodes mounted on a printed circuit board.

12. The lighting device of claim 1, wherein the light source is connected to a power cable via a plurality of flat flexible cables.

13. A lighting device comprising:
a vertical support;
an elongate arm connected to the vertical support via a connector; and
a light source mounted on the arm; wherein:
the elongate arm has a length and a first plurality of elongate channels formed along at least a portion of its length, and
the connector comprises a sheet structure having a first plurality of wheels rotatably mounted thereon, wherein each of the first plurality of wheels is arranged and configured to ride along at least one of the first plurality of elongate channels, such that the elongate arm can slide relative to the vertical support in a direction parallel to the length of the arm.

14. The lighting device of claim 13, wherein the first plurality of wheels consists of three wheels, wherein two of the three wheels are rotatably mounted to the sheet structure and ride along a first elongate channel formed in a first surface of the horizontal arm, and the third of the three wheels is rotatably mounted to the sheet structure and rides along a second elongate channel formed in a second surface of the horizontal arm.

15. The lighting device of claim 14, wherein the first and second surfaces may be horizontal surfaces.

16. The lighting device of claim 14, wherein each of the three first plurality of wheels is mounted to the sheet structure via a mounting stud or bushing.

17. The lighting device of claim 16, wherein two of the three first plurality of wheels are mounted concentrically and the third of the three first plurality of wheels is mounted eccentrically.

18. The lighting device of claim 13, wherein the elongate arm consists or, of consists essentially of, a heat sink and the first plurality of elongate channels are separated by elongate fins formed along at least a portion of the length of the heat sink.

19. The lighting device of claim 13, wherein the vertical support comprises an elongate support having a length and a second plurality of elongate channels formed along at least a portion of its length.

20. The lighting device of claim 19, wherein the sheet structure of the connector has a second plurality of wheels rotatably mounted thereon, wherein each of the second plurality of wheels is arranged and configured to ride along at least one of the second plurality of elongate channels, such that the elongate arm can slide relative to the vertical support in a direction parallel to the length of the vertical support.

21. The lighting device of claim 20, wherein the first plurality of wheels is mounted on a first side of the sheet structure, and the second plurality of wheels is mounted on a second side of the sheet structure which is opposite to the first side.

22. The lighting device of claim 20, wherein the second plurality of wheels consists of three wheels, wherein two of the three wheels are rotatably mounted to the sheet structure and ride along a first of the second plurality of elongate channels which is formed in a first vertical surface of the vertical support, and the third of the three wheels is rotatably mounted to the sheet structure and rides along a second of the second plurality of elongate channels which is formed in a second vertical surface of the vertical support.

23. The lighting device of claim 22, wherein each of the three wheels of the second plurality of wheels is mounted to the sheet structure via a mounting stud or bushing.

24. The lighting device of claim 23, wherein two of the three second plurality of wheels are mounted concentrically, and the third of the three second plurality of wheels is mounted eccentrically.

25. The lighting device of claim 13, wherein the light source is connected to a power cable via a plurality of flat flexible cables.

26. The lighting device of claim 25, wherein:
the light source is connected to a first end of a first flat flexible cable which runs along at least a portion of the elongate arm;
a second end of the first flat flexible cable is connected to a first electrical contact positioned on a first side of the sheet structure of the connector;
the first electrical contact is connected to a second electrical contact on an opposite side of the sheet structure of the connector;
the second electrical contact is connected to a first end of a second flat flexible cable which runs along at least a portion of the vertical support; and
a second end of the second flat flexible cable is electrically connectable to a power supply.

27. A lighting device comprising:
a vertical support;
an arm connected to the vertical support via a first connector;
a light source mounted on the arm and electrically connected to the first connector;
a counterweight connected to a first pulley wheel;
a second electrical connector mounted in a fixed position close to an upper end of the vertical support, wherein the second electrical connector is connectable to a power source;
a second pulley wheel rotatably mounted in a fixed position close to an upper end of the vertical support and above the second electrical connecter; and
a first flexible flat power cable which runs along at least a portion of the vertical support, wherein the first power cable has a first end electrically connected to the first connector, and a second end electrically connected to the second electrical connector, wherein the first power cable is arranged to pass over an upper portion of the second pulley and under a lower portion of the first pulley, such that movement of the arm and first connector in a vertical direction causes movement of the counterweight in an opposite vertical direction.

28. The lighting device of claim 27, further comprising a second power cable which runs along at least a portion of the vertical support, the second power cable having a first end which is connected to a plug that is electrically connectable to a power source, and a second end which is connected to, or forms, the second electrical connector.

29. The lighting device of claim 28, wherein the first end of the second power cable is connected to a jack plug positioned at a lower end of the vertical support.

30. The lighting device of claim 28, further comprising a third power cable which runs along at least a portion of the arm and is electrically connected to the first connector and the light source.

31. The lighting device of claim 27, wherein the counterweight has a weight equal to substantially double a total weight of the arm, light source, first power cable, first connector and any other components mounted on the arm.

32. The lighting device of claim 27, wherein the counterweight includes lugs which are arranged to slide within an elongate channel formed in a side of the vertical support.

33. A lighting device comprising:
a plurality of light emitting diodes, each light emitting diode including an integral lens, wherein each of the light emitting diodes is mounted with its lens pointing in the same direction; and
a plurality of frustoconical surfaces, each of the frustoconical surfaces being bounded by a first opening and a second opening wider than the first opening, wherein each of the light emitting diodes is mounted such that its lens is positioned within the first opening of a corresponding one of the frustoconical surfaces.

34. The lighting device of claim 33, wherein each light emitting diode has an axis along which a maximum intensity of light is emitted, and each light emitting diode is arranged so that its axis is aligned with the axis of rotation of a respective frustoconical surface.

35. The lighting device of claim 33, wherein the plurality of frustoconical surfaces are formed such that their second openings are formed within a single flat surface.

36. The lighting device of claim 33, wherein each frustoconical surface is positioned such that its second opening meets a second opening of an adjacent frustoconical surface at a point.

37. The lighting device of claim 33, wherein the plurality of light emitting diodes are arranged in a straight line with their axes parallel to one another, and the plurality of frustoconical surfaces are aligned in a straight line with their axes of rotation aligned parallel to one another.
